(19) United States
(12) Patent Application Publication
(10) Pub. No.: US 2020/0298539 A1
(43) Pub. Date: Sep. 24, 2020

(54) PLASTIC PRODUCT INCLUDING SYNTHETIC POLYMER FILM

(71) Applicant: Sharp Kabushiki Kaisha, Sakai City (JP)

(72) Inventors: Yasuhiro SHIBAI, Sakai City (JP); Yu YAMANE, Sakai City (JP); Tokio TAGUCHI, Sakai City (JP)

(21) Appl. No.: 16/820,901

(22) Filed: Mar. 17, 2020

(30) Foreign Application Priority Data
Mar. 20, 2019 (JP) 2019-053381

(51) Int. Cl. B32B 27/08; B32B 27/20; B32B 27/30; B32B 27/32; B32B 3/30

(52) U.S. Cl. CPC B32B 27/08; B32B 27/20; B32B 27/30; B32B 2310/0831; B32B 3/30; B32B 2305/72; B32B 27/325

(57) ABSTRACT

A plastic product includes: a plastic base having a surface, the surface being made of a cycloolefin polymer; and a synthetic polymer film formed on the surface of the plastic base. The synthetic polymer film is formed from a photocurable resin containing an oxime ester-based photopolymerization initiator in an amount of not less than 0.1 mass % and not more than 5 mass % on the basis of the entire photocurable resin.

### BACKGROUND

### 1. Technical Field

The present invention relates to a plastic product including a synthetic polymer film.

### 2. Description of the Related Art

An antireflection technique which has been receiving attention in recent years is forming over a substrate surface a microscopic uneven pattern in which the interval of recessed portions or raised portions is not more than the wavelength of visible light (λ=380 nm to 780 nm). See Japanese Patent No. 4265729 and Japanese Laid-Open Patent Publication No. 2009-166502. The two-dimensional size of a raised portion of an uneven pattern which performs an antireflection function is not less than 10 nm but less than 500 nm. Here, the “two-dimensional size” of the raised portions refers to the area equivalent circle diameter of the raised portions viewed in a direction normal to the surface. For example, when the raised portions have a conical shape, the two-dimensional size of the raised portions is equivalent to the diameter of the base of the cone. The same applies to the “two-dimensional size” of the recessed portions.

The present applicant conceived a method for producing an antireflection film (an antireflection surface) which has a moth-eye structure with the use of an anodized porous alumina layer. Using the anodized porous alumina layer enables manufacture of a mold which has an inverted moth-eye structure with high mass producibility (see, for example, Japanese Patent No. 4265729, Japanese Laid-Open Patent Publication No. 2009-166502, WO 2011/125486, and WO 2013/183576). The entire disclosures of Japanese Patent No. 4265729, Japanese Laid-Open Patent Publication No. 2009-166502, WO 2011/125486, and WO 2013/183576 are incorporated by reference in this specification.

The present applicant developed the above-described technology and arrived at a synthetic polymer film whose surface has a microbicidal effect (see, for example, WO 2015/163018). The entire disclosures of WO 2015/163018 are incorporated by reference in this specification.

### SUMMARY

The Applicant has developed a synthetic polymer film which excels in terms of adhesion with respect to PC (polycarbonate)(International Publication No. 2018/154843). According to a study by the inventors, however, the synthetic polymer film described in International Publication No. 2018/154843 may provide sufficient adhesion with respect to PC (polycarbonates), but may not provide sufficient adhesion with respect to COP (cycloolefin polymers).

This problem is not limited to synthetic polymer films having a microscopic uneven structure (e.g., a moth-eye structure) on its surface, but is common to any synthetic polymer film that lacks surficial structures, i.e., having a flat plane. For example, Japanese Laid-Open Patent Publication No. 2013-186236 discloses a film that includes a COP film and a synthetic polymer film (hardcoat layer) formed on the COP film, where the synthetic polymer film (hardcoat layer) is described as having good adhesion with the COP film. However, according to a study by the inventors, the synthetic polymer film described in Japanese Laid-Open Patent Publication No. 2013-186236 may not even provide sufficient adhesion with respect to COP.

A main objective of the present invention is to improve adhesion of a synthetic polymer film with respect to cycloolefin polymers, and to provide a plastic product that includes: a plastic base having a surface which is made of a cycloolefin polymer; and a synthetic polymer film formed on the surface of the plastic base, the synthetic polymer film having an improved adhesion with respect to the cycloolefin polymer.

According to an embodiment of the present invention, solutions as described in the following Items are provided.

[Item 1]

A plastic product comprising: a plastic base having a surface, the surface being made of a cycloolefin polymer; and a synthetic polymer film formed on the surface of the plastic base, wherein

the synthetic polymer film is formed from a photocurable resin containing an oxime ester-based photopolymerization initiator in an amount of not less than 0.1 mass % and not more than 5 mass % on the basis of the entire photocurable resin.

[Item 2]

The plastic product of Item 1, wherein an SP value of a monomer component in the photocurable resin is 9.8 or less.

[Item 3]

The plastic product of Item 1, wherein an SP value of a monomer component in the photocurable resin is 9.6 or less.

[Item 4]

The plastic product of any of Items 1 to 3, wherein the photocurable resin comprises a 2-(2-vinyloxy ethoxy)ethyl (meth)acrylate monomer.

[Item 5]

The plastic product of any of Items 1 to 4, wherein the photopolymerization initiator comprises ethanone,1-[9-ethyl-6-(2-methylbenzoyl)-9H-carbazole-3-yl]-,1-(O-acetyloxime).

[Item 6]

The plastic product of any of Items 1 to 5, wherein a static contact angle of water with respect to the surface of the plastic base is 65° or less.

[Item 7]

The plastic product of any of Items 1 to 5, wherein a static contact angle of water with respect to the surface of the plastic base is 55° or less.

[Item 8]

The plastic product of any of Items 1 to 7, wherein the surface of the plastic base has been subjected to a surface roughening treatment. For example, the surface of the plastic base has been subjected to at least one treatment selected from the group consisting of a corona treatment, a UV treatment, a glow discharge treatment, and an ozone treatment.

[Item 9]

The plastic product of any of Items 1 to 8, wherein an arithmetic average roughness Ra of the surface of the plastic base is not less than 2 nm and not more than 15 nm.

[Item 10]

The plastic product of any of Items 1 to 9, wherein the photocurable resin comprises a fluorine element.

[Item 11]

The plastic product of any of Items 1 to 10, wherein, when viewed from a normal direction of the synthetic polymer film, the synthetic polymer film has a plurality of raised portions on a surface thereof, the plurality of raised portions having a two-dimensional size in the range of more than 20 nm and less than 500 nm.

[Item 12]

The plastic product of any of Items 1 to 11, wherein the synthetic polymer film is formed from a photocurable resin composition comprising the photocurable resin and a filler mixed therein.

According to an embodiment of the present invention, there is provided a plastic product that includes: a plastic base having a surface which is made of a cycloolefin polymer; and a synthetic polymer film formed on the surface of the plastic base, the synthetic polymer film having an improved adhesion with respect to the cycloolefin polymer.

### BRIEF DESCRIPTION OF THE DRAWINGS

FIG. 1A, FIG. 1B, and FIG. 1C are schematic cross-sectional views of synthetic polymer films 34A, 34B and 34C of an embodiment of the present invention respectively.

### DETAILED DESCRIPTION

Hereinafter, a synthetic polymer film and a synthetic polymer film production method according to an embodiment of the present invention are described with reference to the drawings.

The present applicant conceived a method for producing an antireflection film (an antireflection surface) which has a moth-eye structure with the use of an anodized porous alumina layer. Using the anodized porous alumina layer enables manufacture of a mold which has an inverted moth-eye structure with high mass producibility.

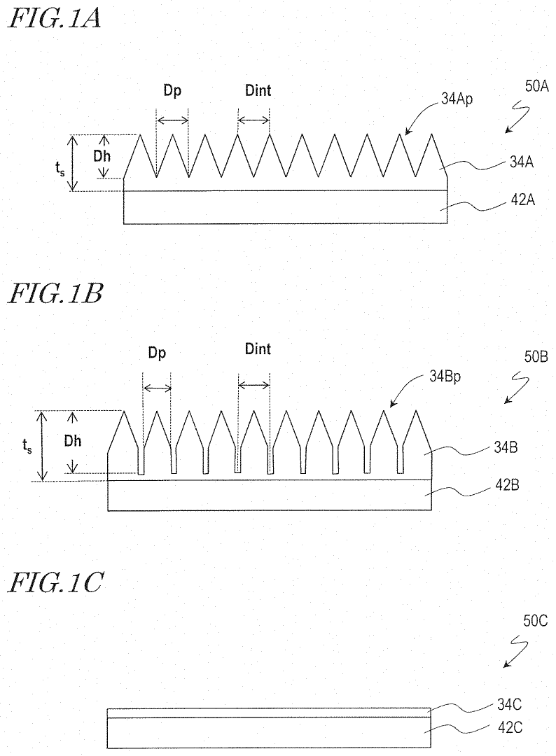

The configuration of a synthetic polymer film according to an embodiment of the present invention is described with reference to FIG. 1A, FIG. 1B and FIG. 1C.

FIG. 1A and FIG. 1B respectively show schematic cross-sectional views of synthetic polymer films 34A and 34B according to embodiments of the present invention. The synthetic polymer films 34A and 34B described herein as examples are formed on base films 42A and 42B, respectively, although the present invention is not limited to these examples. The synthetic polymer films 34A and 34B can be directly formed on a surface of an arbitrary object.

A film 50A shown in FIG. 1A includes a base film 42A and a synthetic polymer film 34A provided on the base film 42A. The synthetic polymer film 34A has a plurality of raised portions 34Ap over its surface. The plurality of raised portions 34Ap constitute a moth-eye structure. When viewed in a normal direction of the synthetic polymer film 34A, the two-dimensional size of the raised portions 34Ap, Dₚ, is in the range of more than 20 nm and less than 500 nm. Here, the “two-dimensional size” of the raised portions 34Ap refers to the diameter of a circle equivalent to the area of the raised portions 34Ap when viewed in a normal direction of the surface. When the raised portions 34Ap have a conical shape, for example, the two-dimensional size of the raised portions 34Ap is equivalent to the diameter of the base of the cone. The typical adjoining distance of the raised portions 34Ap, Dᵢₙₜ, is more than 20 nm but not more than 1000 nm. When the raised portions 34Ap are densely arranged so that there is no gap between adjoining raised portions 34Ap (e.g., the bases of the cones partially overlap each other) as shown in FIG. 1A, the two-dimensional size of the raised portions 34Ap, Dₚ, is equal to the adjoining distance Dᵢₙₜ. The typical height of the raised portions 34Ap, Dₕ, is not less than 50 nm but less than 500 nm. The height Dₕ of the raised portions 34Ap may be not more than 150 nm. The thickness of the synthetic polymer film 34A, tₛ, is not particularly limited but only needs to be greater than the height Dₕ of the raised portions 34Ap.

The synthetic polymer film 34A shown in FIG. 1A has the same moth-eye structure as the antireflection films disclosed in Japanese Patent No. 4265729, Japanese Laid-Open Patent Publication No. 2009-166502, WO 2011/125486 and WO 2013/183576. From the viewpoint of producing an antireflection function, it is preferred that the surface has no flat portion, and the raised portions 34Ap are densely arranged over the surface. Further, the raised portions 34Ap preferably has a such shape that the cross-sectional area (a cross section parallel to a plane which is orthogonal to an incoming light ray, e.g., a cross section parallel to the surface of the base film 42A) increases from the air side to the base film 42A side, e.g., a conical shape. From the viewpoint of suppressing interference of light, it is preferred that the raised portions 34Ap are arranged without regularity, preferably randomly. However, these features are unnecessary when the uneven structure of the synthetic polymer film 34A is utilized only for the purpose of achieving a so-called Lotus effect. For example, the raised portions 34Ap do not need to be densely arranged. The raised portions 34Ap may be regularly arranged.

A film 50B shown in FIG. 1B includes a base film 42B and a synthetic polymer film 34B provided on the base film 42B. The synthetic polymer film 34B has a plurality of raised portions 34Bp over its surface. The plurality of raised portions 34Bp constitute a moth-eye structure. In the film 50B, the configuration of the raised portions 34Bp of the synthetic polymer film 34B is different from that of the raised portions 34Ap of the synthetic polymer film 34A of the film 50A. Descriptions of features which are common with those of the film 50A are sometimes omitted.

When viewed in a normal direction of the synthetic polymer film 34B, the two-dimensional size of the raised portions 34Bp, Dₚ, is in the range of more than 20 nm and less than 500 nm. The typical adjoining distance of the raised portions 34Bp, Dᵢₙₜ, is more than 20 nm but not more than 1000 nm, and Dₚ<Dᵢₙₜ holds. That is, in the synthetic polymer film 34B, there is a flat portion between adjoining raised portions 34Bp. The raised portions 34Bp have the shape of a cylinder with a conical portion on the air side. The typical height of the raised portions 34Bp, Dₕ, is not less than 50 nm but less than 500 nm. The raised portions 34Bp may be arranged regularly or may be arranged irregularly. When the raised portions 34Bp are arranged regularly, Dᵢₙₜ also represents the period of the arrangement. This also applies to the synthetic polymer film 34A, as a matter of course.

In this specification, the “moth-eye structure” includes not only surficial nanostructures that have an excellent antireflection function and that are formed by raised portions which have such a shape that the cross-sectional area (a cross section parallel to the film surface) increases, as in the raised portions 34Ap of the synthetic polymer film 34A shown in FIG. 1A, but also surficial nanostructures that are formed by raised portions which have a part where the cross-sectional area (a cross section parallel to the film surface) is constant, as in the raised portions 34Bp of the synthetic polymer film 34B shown in FIG. 1B. Note that, however, the tip of the conical portion may be rounded.

As disclosed in WO 2015/163018, the synthetic polymer film may further have a plurality of second raised portions which are superimposedly formed over a plurality of first raised portions. Herein, raised portions of the above-described synthetic polymer film which have a two-dimensional size in the range of more than 20 nm and less than 500 nm are referred to as “first raised portions”. The two-dimensional size of the second raised portions is smaller than the two-dimensional size of the first raised portions and does not exceed 100 nm.

A mold for forming a moth-eye structure such as illustrated in FIG. 1A and FIG. 1B over the surface (hereinafter, referred to as “moth-eye mold”) has an inverted moth-eye structure obtained by inverting the moth-eye structure. Using an anodized porous alumina layer which has the inverted moth-eye structure as a mold without any modification enables inexpensive production of the moth-eye structure. Particularly when a moth-eye mold in the shape of a hollow cylinder is used, the moth-eye structure can be efficiently manufactured according to a roll-to-roll method. Such a moth-eye mold can be manufactured according to methods disclosed in Japanese Laid-Open Patent Publication No. 2009-166502, WO 2011/125486, WO 2013/183576 and WO 2015/163018. That is, by alternately and repeatedly performing the anodization step and the etching step on an aluminum film deposited on a base or on an aluminum base through multiple cycles, a moth-eye mold is obtained which includes a porous alumina layer which has an inverted moth-eye structure.

The surface of each of the synthetic polymer films 34A and 34B has the moth-eye structure obtained by inverting the surficial nanostructure of the moth-eye mold. According to the surficial nanostructure of the moth-eye mold used, the synthetic polymer films 34A and 34B shown in FIG. 1A and FIG. 1B, respectively, can be produced. The material that forms the synthetic polymer films 34A and 34B is not limited to the UV-curable resin but may be a photocurable resin which is curable by visible light.

A film 50C shown in FIG. 1C includes a base film 42C and a synthetic polymer film 34C formed on the base film 42C. The film 50C differs from the synthetic polymer film 34A of the film 50A and the synthetic polymer film 34B of the film 50B, in that the synthetic polymer film 34C lacks surficial structures. In other words, the synthetic polymer film 34C has a flat surface. Description of any features that are common to the films 50A and 50B may be omitted.

Studies by the inventors have identified cases where the synthetic polymer films described in International Publication No. 2018/154843 and Japanese Laid-Open Patent Publication No. 2013-186236, supra, do not provide sufficient adhesion with respect to cycloolefin polymers (COP). A COP is amorphous and therefore excels in transparency, and is lower in polarity and hence hygroscopicity than e.g. TAC (triacetyl cellulose), and yet has a better processibility than that of glass. Because of such characteristics, COPs may be suitably used for cell culture or food purposes, for example. The inventors have found that a synthetic polymer film which is formed by using a photocurable resin containing an oxime ester-based photopolymerization initiator, the initiator accounting for a predetermined proportion in the entire photocurable resin, provides excellent adhesion with respect to a base that is made of a cycloolefin polymer (COP).

[Synthetic Polymer Film]

Sample films were produced by using UV-curable resins of different compositions. The materials used in the curable resin compositions for forming the synthetic polymer films in the respective sample films are shown in Table 1.

TABLE 1

| | | | Product | Manufacturer | | | |
|---|---|---|---|---|---|---|---|
| Materials | | Abbreviation | Name | Name | Compound Name | MW | SP |
| Monomer | | M300 | Miramer | MIWON | trimethylolpropane | 296 | 9.88 |
| | | | M300 | | triacrylate | | |
| | | M282 | Miramer | MIWON | polyethylene glycol | 308 | 9.72 |
| | | | M282 | | (200)diacrylate | | |
| | | VEEA | VEEA | NIPPON | 2-(2-vinyloxy ethoxy)ethyl | 186 | 9.2 |
| | | | | SHOKUBAI | acrylate | | |
| | | | | CO., LTD. | | | |
| | | M222 | M222 | MIWON | dipropylene glycol | 242 | 9.46 |
| | | | | | diacrylate | | |
| | | ACMO | ACMO | KJ Chemicals | N,N-acryloylmorpholine | 99 | 11.95 |
| | | | | Corporation | | | |
| | | U10HA | U10HA | SHIN- | urethane acrylate | 850 | 10.74 |
| | | | | NAKAMURA | | | |
| | | | | CHEMICAL | | | |
| | | | | CO. LTD. | | | |
| Mold Releasing Agent | | FAAC6 | FAAC-6 | Unimatec | 2-(perfluorohexyl)ethyl | | |
| | | | | Corporation | acrylate | | |
| Polymerization | oxime ester- | OXE02 | IRGACURE | BASF | ethanone,1-[9-ethyl-6-(2- | — | |
| Initiator | based | | OXE02 | | methylbenzoyl)-9H- | | |
| | | | | | carbazol-3-yl]-,1-(O- | | |
| | | | | | acetyloxime) | | |
| | | OXE01 | IRGACURE | BASF | 1,2-Octanedione,1-[4- | — | |
| | | | OXE01 | | (phenylthio)phenyl]-,2-(o- | | |
| | | | | | benzoyloxime) | | |
| | acylphosphine | 819 | Omnirad 819 | IGM Resins | bis(2,4,6-trimethylbenzoyl)- | — | |
| | oxide-based | | | | phenylphosphine oxide | | |
| | | TPO | Omnirad | IGM Resins | diphenyl(2,4,6- | — | |
| | | | TPO | | trimethylbenzoyl)phosphine | | |
| | | | | | oxide | | |
| | alkylphenone- | 184 | Omnirad 184 | IGM Resins | 1-Hydroxycyclohexyl- | — | |
| | based | | | | phenyl ketone | | |
| | | 2959 | Omnirad | IGM Resins | 1-[4-(2-hydroxyethoxy)- | — | |
| | | | 2959 | | phenyl]-2-hydroxy-2- | | |
| | | | | | methyl-1-propane-1-one | | |

| | | | | |
|---|---|---|---|---|
| Fine particles | Silica | QSG-30 | Shin-Etsu | silica fine particles (30 nm) |
| | | | Chemical | |
| | | | Co., Ltd. | |
| | PMMA | Techpolymer | SEKISUI | PMMA Particles |
| | | MBX-5 | PLASTICS | (5 μm) |
| | | | CO., LTD. | |

The sample films produced were Examples 1 to 11 according to an embodiment of the present invention, and Comparative Examples 1 to 8. Each of the sample films of Examples 1 to 10 and Comparative Examples 1 to 7, as does the film 50A shown in FIG. 1A, includes a base film 42A and a synthetic polymer film 34A formed on the base film 42A, the synthetic polymer film 34A having a moth-eye structure on its surface. Each of the sample films of Example 11 and Comparative Example 8, as does the film 50C shown in FIG. 1C, includes a base film 42C and a synthetic polymer film 34C formed on the base film 42C, the synthetic polymer film 34C having a flat surface.

Tables 2 to 4 show the compositions of resin compositions which were used in forming the respective synthetic polymer films. Table 2 illustrates the sample films of Examples 1 to 10; Table 3 illustrates the sample films of Comparative Examples 1 to 7; and Table 4 illustrates the sample films of Example 11 and Comparative Example 8. In Tables 2 to 4, % represents mass %.

In the present specification, it is assumed that a “UV-curable resin (photocurable resin)” contains a mold releasing agent (e.g., “mold releasing agent” FAAC6 in Examples 1 to 10) as well as monomers and a photopolymerization initiator, but does not contain any filler (e.g., “fine particles” silica and PMMA in Example 11). It is assumed however that a “UV-curable resin composition (photocurable resin composition)” contains all such monomers, a photopolymerization initiator, a mold releasing agent, a filler, and the like. Table 4 shows, with respect to each of Example 11 and Comparative Example 8: (upper row) the proportions of respective components on the basis of the entire UV-curable resin (containing “monomers” and an “initiator”, but not containing any filler denoted as “fine particles”); and (lower row) the proportions of respective components on the basis of the entire UV-curable resin composition (containing “monomers”, an “initiator”, and “fine particles”).

Tables 2 to 4 also show an SP value (solubility parameter) of the entire monomer component of the UV-curable resin composing the synthetic polymer film of each sample film. This SP value is derived from the SP value of each monomer as shown in Table 1, and from the mass proportion of each monomer in the entire monomer component in the UV-curable resin. The SP value, which is a physical property value defined by a square root of cohesive energy density, is a numerical value indicating the dissolving behavior of a given substance in a solvent. It is empirically known that substances of close solubility parameter values are likely to be miscible.

Tables 5 to 7 show, with respect to each sample film: the mold sample which was used in producing the synthetic polymer film; the type of base film; and evaluation results regarding adhesion of the synthetic polymer film with respect to the base film. Table 5 illustrates the sample films of Examples 1 to 10; Table 6 illustrates the sample films of Comparative Examples 1 to 7; and Table 7 illustrates the sample films of Example 11 and Comparative Example 8.

(Mold Sample)

The respective sample films of Examples 1 to 10 and Comparative Examples 1 to 7 were produced by using a moth-eye mold (a mold for forming a moth-eye structure on a surface) in the following manner.

For the moth-eye mold, “moth-eye 1” as described in International Patent Application No. PCT/JP2019/031657 by the Applicant et al. was used. Specifically, a porous alumina layer which was produced by the method described in Japanese Patent No. 4265729, Japanese Laid-Open Patent Publication No. 2009-166502, WO 2011/125486, and WO 2013/183576, supra, was provided. Before forming the synthetic polymer film 34A, a mold releasing treatment was performed for the mold surface by using a fluorine-based mold releasing agent UD509 (OPTOOL UD509, modified perfluoropolyether, manufactured by DAIKIN INDUSTRIES, LTD.) which had been diluted to a concentration of 0.1%.

As a parameter characterizing the surface of the moth-eye mold, a static contact angle of pure water with respect to the surface was measured. The contact angle (static contact angle) was measured by a generic θ/2 method (half-angle Method: (θ/2=arctan(h/r), θ: contact angle, r: radius of liquid drop, h: height of liquid drop)). The contact angle measurements of pure water were taken by using a 1 μL liquid drop. Since the contact angle would change over time, a contact angle after the lapse of 1 second and a contact angle after the lapse of 10 seconds since adhesion of the drop were measured. In either case, the liquid drop did not land on the surface of the moth-eye mold. In other words, the contact angle was 140° or more.

By using the aforementioned moth-eye mold, sample films were produced by two kinds of methods, i.e., Spec 1 and Spec 2, for each of Examples 1 to 10 and Comparative Examples 1 to 7.

Under Spec 1, the UV-curable resin was applied onto the surface of the base film 42A by using bar coater No. 10. Under Spec 2, the UV-curable resin was applied onto the surface of the moth-eye mold (i.e., a surface having the inverted moth-eye structure). Next, under both of Spec 1 and Spec 2, with the UV-curable resin having been applied between the moth-eye mold and the surface of the base film 42A, the base film 42A was placed onto the moth-eye mold, and evenly pressed against the mold by using a hand roller. Next, ultraviolet light (UV) was radiated through the base film 42A to cure the UV-curable resin, whereby a sample film having the synthetic polymer film 34A on the base film 42A was obtained. In other words, under Spec 1, the UV-curable resin was cured by irradiating the UV-curable resin with ultraviolet light while the base film 42A having the UV-curable resin applied on its surface was pressed against the moth-eye mold. Under Spec 2, the UV-curable resin was cured by irradiating the UV-curable resin with ultraviolet light while the base film 42A was pressed against the moth-eye mold having the UV-curable resin applied on its surface. Thereafter, under both of Spec 1 and Spec 2, the moth-eye mold was separated from the base film 42A, whereby a synthetic polymer film 34A having a transferred structure of the inverted moth-eye structure of the moth-eye mold was formed on the surface of the base film 42A. Under both of Spec 1 and Spec 2, the exposure amount was 1 J/cm² (on the basis of light at the wavelength of 375 nm). In each sample film, Dₚ was about 200 nm, Dᵢₙₜ was about 200 nm, Dₕ was about 150 nm, and tₛ was 9.3 μm. In each sample, the synthetic polymer film was produced without using a solvent. In the ultraviolet light irradiation, a UV lamp manufactured by Fusion UV Systems (product name: LIGHT HANMAR6J6P3) was used.

The sample films of Example 11 and Comparative Example 8 were produced, each in duplicate by the two kinds of methods of Spec 1 and Spec 2, in the following manner.

The materials shown in Table 1 were agitated at 2000 rpm for 60 minutes by using an agitator to give each UV-curable resin composition. The resultant UV-curable resin composition was applied onto the surface of the base film 42C. Under Spec 1, without using any mold, the UV-curable resin composition having been applied on the base film 42C was irradiated with ultraviolet light, whereby the UV-curable resin composition was cured. Under Spec 2, a piece of glass whose surface had been treated with a fluorine-based mold releasing agent was used as a mold, and while the base film 42C having the UV-curable resin composition applied on its surface was pressed against the mold, the UV-curable resin composition was irradiated with ultraviolet light, whereby the UV-curable resin composition was cured. Under both of Spec 1 and Spec 2, the exposure amount was 1 J/cm². Under both of Spec 1 and Spec 2, the resultant synthetic polymer film 34C had a thickness of 5.5 μm.

(Base Film)

As the base films 42A and 42C, COP films having a thickness of 100 μm (“ZEONOR film ZF14-100” manufactured by Zeon Corporation) were used (ZEONOR film is a registered trademark).

The surface of each base film (i.e., the surface on which the synthetic polymer film is supported) was subjected to a surface treatment. As a parameter characterizing the base film surface, a static contact angle of pure water was measured. Measurement of the contact angle of pure water was performed by a similar method to the above. Herein, by using a 1 μL drop of pure water, a contact angle after the lapse of 1 second since adhesion of the drop was measured. Information regarding the surface treatment and measurement results of contact angle are shown in Tables 5 to 7.

In Examples 1 to 9 and 11 and Comparative Examples 1 to 6 and 8, the base film surface (i.e., the surface on which the synthetic polymer film was supported) was subjected to a corona treatment. The corona treatment was performed by using a corona treater (designated as RF power wire discharge treatment apparatus AGI-020SF) manufactured by KASUGA DENKI, Inc., with a discharge energy of 15 kJ/m².

The surface of the base film of Example 10 (i.e., the surface on which the synthetic polymer film was supported) was subjected to an excimer UV treatment. The excimer UV treatment was performed by using an excimer UV irradiation apparatus (designated as QEF-100) manufactured by Quark Technology Co., Ltd. The treatment conditions were as follows. With a xenon lamp (wavelength 172 nm), excimer UV light was irradiated at the atmospheric pressure under a nitrogen atmosphere by using the dielectric barrier discharge lamp through the upper face (i.e., the face on which the synthetic polymer film was supported) of the base film. The irradiation intensity directly under the dielectric barrier discharge lamp was 10 mW/cm², and the irradiation time was 2 minutes.

The base film of Comparative Example 7 was not subjected to a surface treatment.

[Evaluation of Adhesion to COP Film]

Evaluations of adhesion of the synthetic polymer film with respect to the base film (COP film) were made in the following manner.

Adhesion evaluations were taken of each of Examples 1 to 11 and Comparative Examples 1 to 8 by the following method, regarding both sample films that were produced by the aforementioned methods of Spec 1 and Spec 2. In particular, in each of Examples 1 to 10 and Comparative Examples 1 to 7, where the moth-eye mold was used, the sample film that was produced under Spec 2 is expected to have lower adhesion than under Spec 1 because the length of time during which the UV-curable resin is in contact with the base film 42A is shorter under Spec 2 than under Spec 1.

First, in an environment where the temperature was 23EC and the humidity was 50%, 11 vertical incisions and 11 horizontal incisions were formed in a surface of a synthetic polymer film of each sample film (a surface opposite to the base film) using a utility knife at intervals of 1 mm in the shape of a grid such that 100 squares (1 mm on each side) were formed. Then, a polyester adhesive tape “No. 31B” manufactured by NITTO DENKO CORPORATION was placed on and pressed against the square portions. Thereafter, the adhesive tape was peeled off in a direction of 90° with respect to the surface of the square portions at a velocity of 100 mm/s. Thereafter, the surface state of the synthetic polymer film on the base film was visually observed, and the number of squares from which the synthetic polymer film on the base film was not removed, M, was counted. The Criteria for judgement were as follows:

### (Adhesion Under Spec 1)

### A: M=100

### B: M=1 to 99

### C: M=0

Herein, when A, the sample film was judged to be at a tolerable level (excellent in adhesion under Spec 1).

### (Adhesion Under Spec 2)

### a: M=100

### b: M=90 to 99

### c: M=0 to 89

Herein, when a or b, the sample film was judged to be at a tolerable level (excellent in adhesion under Spec 2).

TABLE 2

| | | | | | | | | | | | | | Mold |
|---|---|---|---|---|---|---|---|---|---|---|---|---|---|
| | | | | | | | | | | | | | Releasing |
| | Monomer | Monomer | | | | | Initiator | | | | | | Agent |
| Example | SP | M300 | M282 | VEEA | M222 | ACMO | OXE02 | OXE01 | 819 | TPO | 184 | 2959 | FAAC6 |
| Ex. 1 | 9.57 | 18.9% | 42.5% | 33.0% | | | 1.9% | | | | | | 3.8% |
| Ex. 2 | 9.57 | 18.9% | 42.5% | 33.0% | | | | 1.9% | | | | | 3.8% |
| Ex. 3 | 9.57 | 19.1% | 43.0% | 33.5% | | | 0.57% | | | | | | 3.8% |
| Ex. 4 | 9.57 | 18.7% | 42.1% | 32.7% | | | 2.8% | | | | | | 3.7% |
| Ex. 5 | 9.57 | 19.2% | 43.2% | 33.6% | | | 0.19% | | | | | | 3.8% |
| Ex. 6 | 9.57 | 18.3% | 41.3% | 32.1% | | | 4.6% | | | | | | 3.7% |
| Ex. 7 | 9.48 | 12.5% | 33.7% | 48.1% | | | 1.9% | | | | | | 3.8% |
| Ex. 8 | 9.90 | 27.5% | 61.5% | | | 5.5% | 1.8% | | | | | | 3.7% |
| Ex. 9 | 9.66 | 18.9% | 42.5% | | 33.0% | | 1.9% | | | | | | 3.8% |
| Ex. 10 | 9.57 | 18.9% | 42.5% | 33.0% | | | 1.9% | | | | | | 3.8% |

TABLE 3

| | | | | | | | | | | | | | Mold |
|---|---|---|---|---|---|---|---|---|---|---|---|---|---|
| | | | | | | | | | | | | | Releasing |
| Comparative | Monomer | Monomer | | | | | Initiator | | | | | | Agent |
| Example | SP | M300 | M282 | VEEA | M222 | ACMO | OXE02 | OXE01 | 819 | TPO | 184 | 2959 | FAAC6 |
| Cx. 1 | 9.57 | 18.9% | 42.5% | 33.0% | | | | | 1.9% | | | | 3.8% |
| Cx. 2 | 9.57 | 18.9% | 42.5% | 33.0% | | | | | | 1.9% | | | 3.8% |
| Cx. 3 | 9.57 | 18.9% | 42.5% | 33.0% | | | | | | | 1.9% | | 3.8% |
| Cx. 4 | 9.57 | 18.9% | 42.5% | 33.0% | | | | | | | | 1.9% | 3.8% |
| Cx. 5 | 9.57 | 19.2% | 43.2% | 33.6% | | | 0.05% | | | | | | 3.8% |
| Cx. 6 | 9.57 | 18.0% | 40.5% | 31.5% | | | 6.3% | | | | | | 3.6% |
| Cx. 7 | 9.57 | 18.9% | 42.5% | 33.0% | | | 1.9% | | | | | | 3.8% |

TABLE 4

| | Monomer | Monomer | | | Initiator | | Fine particles | |
|---|---|---|---|---|---|---|---|---|
| | SP | M300 | VEEA | U10HA | OXE02 | 184 | Silica | PMMA |
| Ex. 11(Curable Resin) | 9.59 | 34.0% | 53.4% | 9.7% | 2.9% | | | |
| Ex. 11(Curable Resin Composition) | 9.59 | 19.1% | 30.1% | 5.5% | 1.6% | | 21.9% | 21.9% |
| Cx. 8(Curable Resin) | 10.22 | 56.6% | | 37.7% | | 5.7% | | |
| Cx. 8(Curable Resin Composition) | 10.22 | 40.0% | | 26.7% | | 4.0% | 26.7% | 2.7% |

TABLE 5

| | | Base Film | | | | | | |
|---|---|---|---|---|---|---|---|---|
| | | | | Water | | | | |
| | | | | Contact | Adhesion with Base Film | | | |
| | | | | Angle(°), | Spec 1 | | Spec 2 | |
| | | | Surface | 1 second | Remaining | | Remaining | |
| Example | Mold | Material | Treatment | later | Number | Judgment | Number | Judgment |
| Ex. 1 | Moth-Eye | COP | Corona | 51 | 100 | A | 100 | a |
| | Mold | | | | | | | |
| Ex. 2 | Moth-Eye | COP | Corona | 51 | 100 | A | 98 | b |
| | Mold | | | | | | | |
| Ex. 3 | Moth-Eye | COP | Corona | 51 | 100 | A | 100 | a |
| | Mold | | | | | | | |
| Ex. 4 | Moth-Eye | COP | Corona | 51 | 100 | A | 100 | a |
| | Mold | | | | | | | |
| Ex. 5 | Moth-Eye | COP | Corona | 51 | 100 | A | 95 | b |
| | Mold | | | | | | | |
| Ex. 6 | Moth-Eye | COP | Corona | 51 | 100 | A | 94 | b |
| | Mold | | | | | | | |
| Ex. 7 | Moth-Eye | COP | Corona | 51 | 100 | A | 100 | a |
| | Mold | | | | | | | |
| Ex. 8 | Moth-Eye | COP | Corona | 51 | 100 | A | 92 | b |
| | Mold | | | | | | | |
| Ex. 9 | Moth-Eye | COP | Corona | 51 | 100 | A | 98 | b |
| | Mold | | | | | | | |
| Ex. 10 | Moth-Eye | COP | Excimer | 62 | 100 | A | 96 | b |
| | Mold | | UV | | | | | |

TABLE 6

| | | Base Film | | | | | | |
|---|---|---|---|---|---|---|---|---|
| | | | | Water | | | | |
| | | | | Contact | Adhesion with Base Film | | | |
| | | | | Angle(°), | Spec 1 | | Spec 2 | |
| Comparative | | | Surface | 1 second | Remaining | | Remaining | |
| Example | Mold | Material | Treatment | later | Number | Judgment | Number | Judgment |
| Cx. 1 | Moth-Eye | COP | Corona | 51 | 10 | B | 0 | c |
| | Mold | | | | | | | |
| Cx. 2 | Moth-Eye | COP | Corona | 51 | 5 | B | 0 | c |
| | Mold | | | | | | | |
| Cx. 3 | Moth-Eye | COP | Corona | 51 | 40 | B | 0 | c |
| | Mold | | | | | | | |
| Cx. 4 | Moth-Eye | COP | Corona | 51 | 35 | B | 0 | c |
| | Mold | | | | | | | |
| Cx. 5 | Moth-Eye | COP | Corona | 51 | 85 | B | 5 | c |
| | Mold | | | | | | | |
| Cx. 6 | Moth-Eye | COP | Corona | 51 | 95 | B | 45 | c |
| | Mold | | | | | | | |
| Cx. 7 | Moth-Eye | COP | None | 72 | 0 | C | 0 | c |
| | Mold | | | | | | | |

TABLE 7

| | | Base Film | | | | | | |
|---|---|---|---|---|---|---|---|---|
| | | | | Water | | | | |
| | | | | Contact | Adhesion with Base Film | | | |
| | | | | Angle(°), | Spec 1 | | Spec 2 | |
| | | | Surface | 1 second | Remaining | | Remaining | |
| | Mold | Material | Treatment | later | Number | Judgment | Number | Judgment |
| Ex. 11 | Glass Plate | COP | Corona | 51 | 100 | A | 100 | a |
| Cx. 8 | Glass Plate | COP | Corona | 51 | 0 | C | 0 | c |

The evaluation results regarding adhesion between the COP film and the synthetic polymer film as shown in Tables 5 to 7 will be discussed.

The synthetic polymer films of Examples 1 to 6 had excellent adhesion with the COP film; particularly excellent among others were Examples 1 to 4. The synthetic polymer film of Example 1 is formed from a UV-curable resin containing the oxime ester-based photopolymerization initiator OXE02 by 1.9 mass %. Example 2 differs from Example only in that the oxime ester-based photopolymerization initiator OXE01 was used instead of OXE02. Examples 3 to 6 each featured a different proportion of the oxime ester-based photopolymerization initiator OXE02 from that in Example 1. The UV-curable resin in each of Examples 1 to 6 contains monomers by the ratio M300:M282:VEEA=20:45:35. Therefore, the SP values of the monomer components in the UV-curable resins of Examples 1 to 6 are all equal, being 9.57.

Comparative Examples 1 to 4 differs from Example 1 only in that photopolymerization initiators which are not oxime ester-based are used. None of the synthetic polymer films of Comparative Examples 1 to 4 had sufficient adhesion with the COP film. Comparative Examples 5 and 6 differed from Example 1 only in terms of the proportion of the oxime ester-based photopolymerization initiator OXE02. Neither synthetic polymer film of Comparative Example 5 nor 6 had sufficient adhesion with the COP film.

The results of Examples 1 to 6 and Comparative Examples 1 to 6 indicate that, from the viewpoint of adhesion with the COP film, the synthetic polymer film may preferably be formed from a photocurable resin containing an oxime ester-based photopolymerization initiator in an amount of not less than 0.1 mass % and not more than 5 mass % on the basis of the entire photocurable resin. As indicated by the result of Comparative Example 5, when the oxime ester-based photopolymerization initiator accounts for 0.05 mass % or less of the entire photocurable resin, adhesion is not sufficient presumably because of curing insufficiencies. As indicated by the result of Comparative Example 6, when the oxime ester-based photopolymerization initiator accounts for 6.3 mass % or more of the entire photocurable resin, adhesion is not sufficient presumably because of shrinkage upon cure and influences of the polarity of the initiator. From the results of Examples 1 to 6, it is more preferable that the synthetic polymer film is formed from a photocurable resin containing the oxime ester-based photopolymerization initiator by not less than 0.5 mass % and not more than 3 mass %. A more preferable oxime ester-based photopolymerization initiator is OXE02.

In Example 7, the respective monomers have different proportions from those in Example 1. The UV-curable resin of Example 7 contains the monomers by the ratio M300:M282:VEEA=13:35:50. As a result, the SP value of the monomer component in the UV-curable resin of Example 7 is smaller (i.e., 9.48) than the SP value of the monomer component in the UV-curable resin of Example 1. Similarly to Example 1, the synthetic polymer film of Example 7 particularly excelled in adhesion with the COP film.

In Examples 8 and 9, the monomer component in the UV-curable resin is different from that of Example 1. The UV-curable resin of Example 8 contains the monomers by the ratio M300:M282:ACMO=30:67:6. The UV-curable resin of Example 9 contains the monomers by the ratio M300:M282:M222=20:45:35. The SP value of the monomer component in the UV-curable resin of Example 8 is 9.90, whereas the SP value of the monomer component in the UV-curable resin of Example 9 is 9.66. The synthetic polymer film of Example 9 has excellent adhesion with the COP film, although inferior to Example 1. The synthetic polymer film of Example 8 is even more inferior to Example 9.

The results of Examples 1 to 9 indicate that, from the viewpoint of adhesion with the COP film, the SP value of the monomer component contained in the photocurable resin may preferably be 9.8 or less, and more preferably be 9.6 or less. Moreover, the photocurable resin preferably contains a 2-(2-vinyloxy ethoxy)ethyl acrylate monomer. Since COP has low polarity, it is considered that a synthetic polymer film which is formed from monomers of low SP values has excellent adhesion with COP. Furthermore, since COP has a low SP value (ZEONOR film ZF14 used herein has an SP value of 9.1). The difference between the SP value of the COP film and the SP value of the monomer component in the photocurable resin used in producing the synthetic polymer film is preferably not less than 0.1 and not more than 0.7, for example. The presumable tendency among Examples 1 to 9 is that, the smaller the SP values of the monomers from which the synthetic polymer film is made, the smaller its SP value difference with the COP film is, thus resulting in better adhesion with COP. An example of a monomer of a low SP value is a 2-(2-vinyloxy ethoxy)ethyl acrylate monomer, as indicated in Table 1. Furthermore, a 2-(2-vinyloxy ethoxy)ethyl acrylate monomer has a low viscosity (viscosity: 3.65 cP) and therefore a high ability to penetrate into the base film, and thus is believed to enhance adhesion owing to an anchor effect.

As is described in International Publication No. 2018/154843, supra, and Japanese Laid-Open Patent Publication No. 2019-051638, both by the Applicant, the Applicant has found that a 2-(2-vinyloxy ethoxy)ethyl (meth)acrylate monomer is effective as an acrylic monomer for improving the adhesion with respect to a PC film. The entire disclosures of International Publication No. 2018/154843 and Japanese Laid-Open Patent Publication No. 2019-051638 are incorporated by reference in the present specification. For example, any synthetic polymer film that is formed from a photocurable resin containing a 2-(2-vinyloxy ethoxy)ethyl acrylate monomer by 10 mass % to 70 mass % can have excellent adhesion with respect to a PC film.

Instead of a 2-(2-vinyloxy ethoxy)ethyl acrylate monomer (which herein was VEEA manufactured by NIPPON SHOKUBAI CO., LTD.), a 2-(2-vinyloxy ethoxy)ethyl methacrylate monomer (e.g., VEEM manufactured by NIPPON SHOKUBAI CO., LTD.) may be used to obtain similar effects. Collectively, 2-(2-vinyloxy ethoxy)ethyl acrylate monomers and 2-(2-vinyloxy ethoxy)ethyl methacrylate monomers will be referred to as 2-(2-vinyloxy ethoxy)ethyl (meth)acrylate monomers.

In Example 10, the COP film was subjected to an excimer UV treatment as a surface treatment, thus differing from Example 1 (in which the COP film was subjected to a corona treatment). In Example 10, too, the synthetic polymer film and the COP film showed excellent adhesion. In Comparative Example 7, the COP film was not subjected to any surface treatment. Comparative Example 7 did not attain sufficient adhesion with the COP film. It is considered that performing a corona treatment or a UV treatment (e.g., an excimer UV treatment or a plasma UV treatment) for the surface of the COP film will physically roughen the surface (e.g., causing cracks therein), such that adhesion with the synthetic polymer film is improved owing to an anchor effect. Moreover, performing a corona treatment or a UV treatment for the surface of the COP film will introduce a hydrophilic group to the surface, thus improving adhesion with the synthetic polymer film. As the surface roughening treatment for the surface of the COP film, other than the corona treatment and UV treatment that are exemplified herein, a glow discharge treatment or an ozone treatment (including a UV ozone treatment) may be performed, for example. For instance, the arithmetic average roughness Ra of the surface of the COP film is preferably in the range of 2 nm to 15 nm. A COP film having such a surface can be obtained by subjecting the surface of the COP film to a surface roughening treatment. For example, as indicated by the results of Examples 1 to 10, performing a corona treatment or a UV treatment for the surface of the COP film will lower the contact angle of water with respect to the surface of the COP film. The static contact angle of water with respect to the surface of the COP film is preferably 65° or less, and more preferably 55° or less, for example.

The inventors consider the following to be the reason why oxime ester-based photopolymerization initiators are effective for improving adhesion with respect to COP. Note that the following discussion should not constitute any constraints on embodiments of the present invention.

A photopolymerization initiator is decomposed when irradiated with ultraviolet light, and generates radicals. Some of the radicals will react with the atomic group that is generated as a result of cleavage associated with ultraviolet light irradiation, and may generate an acid. Through ultraviolet light irradiation, the oxime ester-based photopolymerization initiator OXE02 is decomposed as expressed by [CHEMICAL FORMULA 1] below, thus generating acetic acid and substance A. Acetic acid has a relatively small molecular weight (boiling point 118° C.), and therefore is unlikely to remain in the synthetic polymer film. Since substance A has a low polarity, even if it remains in the synthetic polymer film without volatilizing, it is considered to remain stable on the surface of COP. Moreover, the synthetic polymer film containing substance A will have low polarity. These are the presumable factors contributing to an improved adhesion with respect to COP.

A photopolymerization initiator 819, which is acylphosphine oxide-based, is decomposed through ultraviolet light irradiation as expressed by [CHEMICAL FORMULA 2] below, thus generating 2, 4, 6-trimethyl benzoic acid and phenyl phosphate. A photopolymerization initiator 2959, which is alkylphenone-based, is decomposed through ultraviolet light irradiation as expressed by [CHEMICAL FORMULA 3] below. The substances (acids, e.g., 2, 4, 6-trimethyl benzoic acid and phenyl phosphate) that are generated from the photopolymerization initiators 819 and 2959 all have little volatility and are likely to remain in the synthetic polymer film. Moreover, the above substances (acids) have high polarity, and therefore have poor miscibility with COP, which has low polarity. Therefore, it is believed likely for the above substances (acids) to remain at the interface of the synthetic polymer film, thereby lowering adhesion with the COP film.

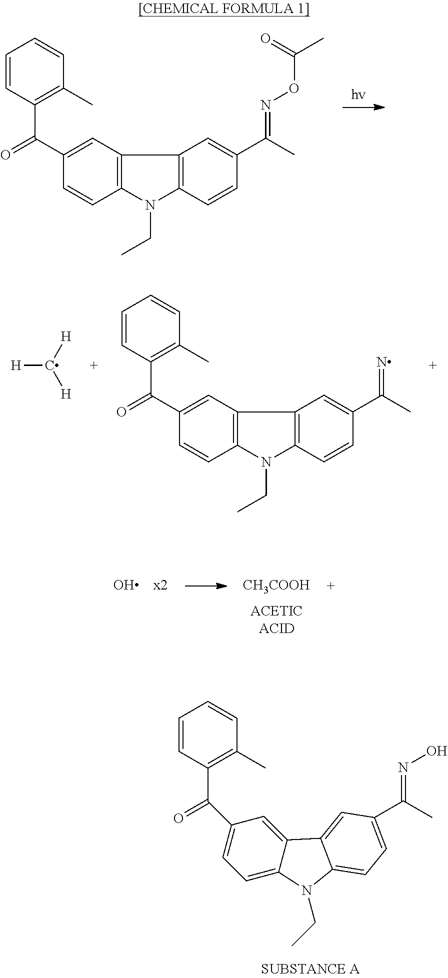

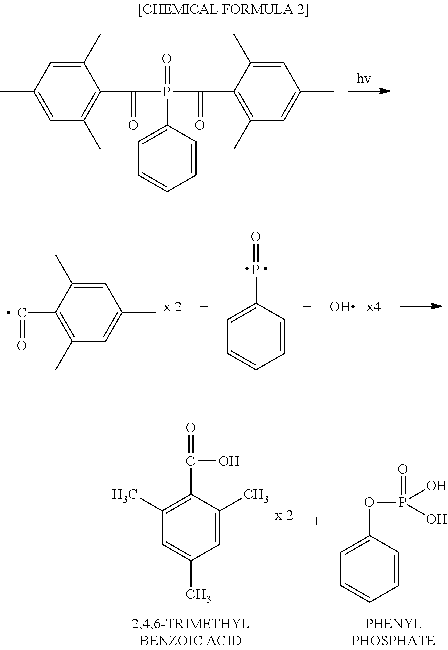

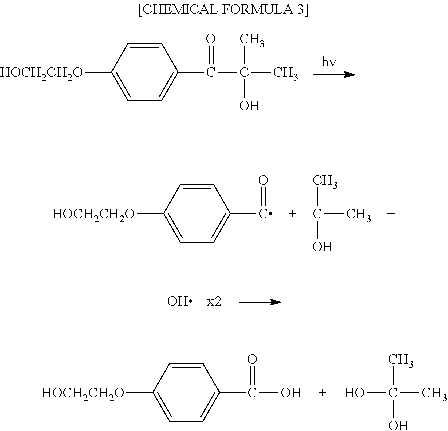

Example 11 and Comparative Example 8 each include a synthetic polymer film 34C having a flat surface, as does the film 50C shown in FIG. 1C. Fine particles of silica QSG-30 (average particle size 30 nm) that are contained in the UV-curable resin compositions of Example 11 and Comparative Example 8 are hydrophobicized at their surfaces. The synthetic polymer film of Example 11 particularly excels in adhesion with the COP film, similarly to Example 1. The synthetic polymer film of Example 11 is formed from a UV-curable resin containing the oxime ester-based photopolymerization initiator OXE02 by 1.6 mass %. The SP value of the monomer component in the UV-curable resin is 9.59, which is on par with Example 1. The synthetic polymer film of Comparative Example 8 does not have sufficient adhesion with the COP film. The synthetic polymer film of Comparative Example 8 is formed from a UV-curable resin containing a photopolymerization initiator that is not oxime ester-based. Moreover, the SP value of the monomer component in the UV-curable resin is 10.22, which is higher than those of Examples 1 to 11.

The synthetic polymer films of Examples 1 to 11 and Comparative Examples 1 to 8 are all formed from UV-curable resins containing the mold releasing agent FAAC6, which includes the fluorine element. In other words, the synthetic polymer films Examples 1 to 11 and Comparative Examples 1 to 8 all contain the fluorine element. The mold releasing agent FAAC6 contains the fluorine element, and is polymerizable. The mold releasing agent FAAC6 is a monofunctional polymerizable fluoric compound. In other words, FAAC6 has one polymerizable functional group. The chemical structural formula of FAAC6 is shown by [CHEMICAL FORMULA 4]. The proportion of fluorine contained in FAAC6 is 59.1 mass %.

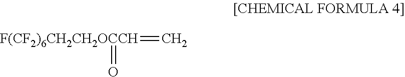

Depending on the use of the synthetic polymer film, for example, e.g., when the synthetic polymer film is expected to have excellent water repellency, it is preferable that the synthetic polymer film contains the fluorine element. As is described in Japanese Laid-Open Patent Publication No. 2019-156879 by the Applicant, the Applicant has developed a synthetic polymer film which has a surface with excellent water repellency and anti-smear property, and yet poses little influence on the pH of water (aqueous solution) that has adhered to its surface. Such a synthetic polymer film can also be used in a three-dimensional cell culture method (International Patent Application No. PCT/JP2019/031657) that has been developed by the Applicant et al., for example. The entire disclosures of Japanese Laid-Open Patent Publication No. 2019-156879 and International Patent Application No. PCT/JP2019/031657 are incorporated by reference in the present specification. As will be described below, a synthetic polymer film according to an embodiment of the present invention can also be suitably used for the three-dimensional cell culture method.

Table 8 shows, regarding Examples 1 and 2, surface characteristics of the synthetic polymer films and results of performing a three-dimensional cell culture on the surface of the synthetic polymer film. As a characteristic of the surface of the synthetic polymer film (which serves as a solid surface in the culture method), a static contact angle of pure water was measured. Measurement of the contact angle was performed by a method similar to the aforementioned method regarding the contact angle for the mold surface, by using a 1 μL drop of pure water. Also, sliding angle measurements were taken by using a 10 μL drop of pure water. A sliding angle refers to, when a surface on which a liquid drop has adhered is inclined from the horizontal direction, a tilt angle at which the liquid drop begins to slide down. The sliding angle was evaluated based on a value after the lapse of 20 seconds since landing. The evaluation of the spheroid was performed, as in the aforementioned International Patent Application No. PCT/JP2019/031657, based on an observation through an optical microscope. At least the sample films of Examples 1 and 2 were confirmed to be available to the three-dimensional cell culture method.

TABLE 8

| | Film Surface Properties | | |
|---|---|---|---|
| | Water | | Culture |
| Example | Contact Angle (°) | Sliding Angle (°) | Spheroid |
| Ex.1 | Not Landed ( >140) | 5° or less | ∘ |
| Ex.2 | Not Landed ( >140) | 5° or less | ∘ |

In the foregoing, examples of multilayer films including a COP film and a synthetic polymer film, where the COP film was used as the base film, were illustrated as examples of plastic products; however, embodiments of the present invention are not limited thereto. For example, a plastic molded product of COP may be used as a plastic base. In other words, a plastic product according to an embodiment of the present invention may include a plastic base which is a plastic molded product of COP and a synthetic polymer film that is formed on the surface of the plastic base. Of the plastic base, at least the surface that comes in contact with the synthetic polymer film may be composed of COP. In the case where a synthetic polymer film having a moth-eye structure on its surface is to be formed on the surface of a plastic molded product of COP, a moth-eye mold may be used which is manufactured by using an aluminum film deposited on a glass base of a desired shape, for example.

A synthetic polymer film according to an embodiment of the present invention excels in terms of adhesion with respect to cycloolefin polymers. A plastic product according to an embodiment of the present invention is suitably used for cell culture and food purposes, for example.

This application is based on Japanese Patent Application No. 2019-053381 filed on Mar. 20, 2019, the entire contents of which are hereby incorporated by reference.

What is claimed is:

1. A plastic product comprising: a plastic base having a surface, the surface being made of a cycloolefin polymer; and a synthetic polymer film formed on the surface of the plastic base, wherein
the synthetic polymer film is formed from a photocurable resin containing an oxime ester-based photopolymerization initiator in an amount of not less than 0.1 mass % and not more than 5 mass % on the basis of the entire photocurable resin.

2. The plastic product of claim 1, wherein an SP value of a monomer component in the photocurable resin is 9.8 or less.

3. The plastic product of claim 1, wherein an SP value of a monomer component in the photocurable resin is 9.6 or less.

4. The plastic product of claim 1, wherein the photocurable resin comprises a 2-(2-vinyloxy ethoxy)ethyl (meth)acrylate monomer.

5. The plastic product of claim 1, wherein the photopolymerization initiator comprises ethanone,1-[9-ethyl-6-(2-methylbenzoyl)-9H-carbazole-3-yl]-,1-(0-acetyloxime).

6. The plastic product of claim 1, wherein a static contact angle of water with respect to the surface of the plastic base is 65° or less.

7. The plastic product of claim 1, wherein a static contact angle of water with respect to the surface of the plastic base is 55° or less.

8. The plastic product of claim 1, wherein the surface of the plastic base has been subjected to a surface roughening treatment.

9. The plastic product of claim 1, wherein an arithmetic average roughness Ra of the surface of the plastic base is not less than 2 nm and not more than 15 nm.

10. The plastic product of claim 1, wherein the photocurable resin comprises a fluorine element.

11. The plastic product of claim 1, wherein, when viewed from a normal direction of the synthetic polymer film, the synthetic polymer film has a plurality of raised portions on a surface thereof, the plurality of raised portions having a two-dimensional size in the range of more than 20 nm and less than 500 nm.

12. The plastic product of claim 1, wherein the synthetic polymer film is formed from a photocurable resin composition comprising the photocurable resin and a filler mixed therein.
